(19) United States
(12) Patent Application Publication
(10) Pub. No.: US 2006/0039603 A1
(43) Pub. Date: Feb. 23, 2006

(54) Automated color classification for biological samples

(76) Inventor: Keith A. Koutsky, Durham, NC (US)

Correspondence Address: ERIC J. KRON;ICORIA, INC., 108 T.W. ALEXANDER DRIVE, BUILDING 1A, POST OFFICE BOX 14528, RESEARCH TRIANGLE PARK, NC, 27709, US

(21) Appl. No.: 10/921,506

(22) Filed: Aug. 19, 2004

(51) Int. Cl. G06K 9/00

(52) U.S. Cl. 382/165

(57) ABSTRACT

The present inventors have developed a way to assign and quantify color in biological samples in an automated environment. The present invention allows for the processing and analysis of a large number of biological samples while providing objective rules for color assignment and quantification within each sample. Methods and systems of the invention allow direct comparison of color from sample to sample, and enable statistical manipulation of larger data sets obtained by the methods and systems of the invention. The invention is highly useful in establishing the health status of the organism from which a sample is obtained.

### FIELD OF THE INVENTION

The present invention pertains to the field of image analysis, and, in particular, to analysis of images of biological samples.

### BACKGROUND

A large number of biological research systems have transitioned to a high-throughput (HT) format in recent years. HT tasks are generally automated to the greatest extent possible to enhance work flow efficiency. Compared to traditional biological research protocols, HT tasking requires a number of adjustments in how experiments are conducted, and in how data are gathered, stored, and analyzed. In order to glean the most information possible from the large data sets often obtained in a HT environment, it is advantageous to use computer support in the capture, storage and analysis of data. Computer automation of tasks conveys many advantages over manual labor, including increased accuracy and speed. Thus it is highly desirable to use automated tasks in biological discovery work.

The automation of biological experimental work is not a simple undertaking, as biological experimental conditions are rarely as straightforward and unchanging as are conditions in other fields in which automation is commonly used, such as manufacturing. The amount of time required for reaching experimental end points (such as growth to a particular developmental stage, or accumulation of a specific cell type or metabolite) can be quite variable from one experiment to the next, and many of the things a biologist wants to measure are also variable from sample to sample, to the extent that it is difficult to automate the measurement process. Especially difficult is the acquisition of images of biological organisms for which morphological features are to be measured, particularly when color attributes are to be quantified. A biological sample's color is generally considered to be subjective and complex, and is not a characteristic that lends itself easily to automation and objective measurement.

### SUMMARY

In one embodiment, the present invention provides computer-implemented methods and systems for classifying color in an image of a biological sample comprising: obtaining an image of a biological sample, the image comprising a plurality of pixels, with each pixel comprising a plurality of color space components; measuring a color attribute for at least one color space component within each pixel in the image; assigning a numerical value representative of the color attribute to each color space component measured within each pixel; and determining a color classification profile for the sample based on the numerical value assigned to each color space component measured.

In another embodiment, the present invention provides computer-implemented methods and systems for classifying color in an image of a biological sample comprising: obtaining an image of a biological sample, the image comprising a plurality of pixels, with each pixel comprising a plurality of color space components; measuring a color attribute for at least one color space component within each pixel in the image; assigning a numerical value, representative of the color attribute, to each color space component measured; defining at least one color designation category by a numerical range; assigning each pixel to a color designation category based on the numerical value assigned to each color space component measured, with the individual numerical values or the proportionalities of the individual numerical values within a pixel contributing to the color designation category assignment; and determining a color classification profile for the sample based on the color designation category assignment for each pixel.

In another embodiment, the present invention provides computer-implemented methods and systems for placing a grid line on an image depicting at least one biological sample, comprising: A computer-implemented method for placement of a grid line on an image depicting at least one biological sample, comprising: (a) establishing an axis of origin and an axis of completion for a grid line to be placed on an image; (b) identifying a group of pixel positions on the axis of origin at which the grid line could originate; (c) determining at least one type of pixel to be excluded from the grid line; (d) selecting a first pixel position from the group of pixel positions on the axis of origin and proceeding toward the axis of completion pixel by pixel until either the axis of completion is reached and a grid line is placed or a pixel to be excluded is encountered; (e) if a pixel to be excluded is encountered, selecting a next pixel position from the group of pixel positions on the axis of origin and proceeding toward the axis of completion pixel by pixel until either the axis of completion is reached and a grid line is placed or a pixel to be excluded is encountered; and (f) if a pixel to be excluded is encountered, repeating step (e) until a grid line position with no pixels to be excluded is found among the group of pixel positions or until every position in the group of pixel positions has been examined.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1. A depiction of a system useful in implementing the current invention. An image of a sample 110 is captured by an image acquisition device 120. The image is stored as data in 130, and the image data are accessed for analysis by using analytical tools 140.

FIG. 2. An output screen of the present invention in which the sample format was potted plants placed in an 8×4 array in a flat.

FIG. 3. A histogram representing use of color to quantify levels of plant stress. The color profiles represent plants grown in media containing differing concentrations of nitrogen. The x-axis indicates the green/red ratio of each pixel. The y-axis indicates percent of total plant area. The nitrogen content corresponds to green/red ratio values of approximately 65-85, while the anthocyanin content corresponds to green/red ratio values of approximately 100-135. The green/red ratio values representative of nitrogen content (approximately 65-85), represented as percent of total plant area, correlated with results obtained from measuring total nitrogen extract from the sample plants.

FIG. 4. A histogram representing use of color to quantify levels of plant stress. The color profiles represent plants grown in media containing differing concentrations of nitrogen. The x-axis indicates the green/red ratio of each pixel. The y-axis indicates percent of total plant area. The nitrogen content corresponds to green/red ratio values of approximately 65-85, while the anthocyanin content corresponds to green/red ratio values of approximately 100-135. The green/red ratio values representative of anthocyanin content (approximately 100-135), represented as percent of total plant area, correlated with results obtained from measuring total anthocyanin extract from the sample plants.

FIG. 5. An image of Arabidopsis thaliana plants grown in low nitrogen growth media.

FIG. 6. Images of Arabidopsis thaliana plants grown in low nitrogen growth media. Samples in an original image (620, lower row) were compared to the pseudo-image of the same samples (610, upper row) created after normalization and after “contrast stretching.” Normalization of the image involved removal of background characteristics, including identification and removal of characteristics such as plant roots, plate ribs, bubbles in media, reflections from plastic plates, and gray (dead) plant leaves.

FIG. 7. An example of development of a set of color designation categories. The methods and systems of the present invention were developed in an iterative process, aided by the use of composite images, until the pseudo-image output results provided by the invention were matched to color assignments made by a skilled human technician. The compiled results represented in FIG. 7 provide numerous examples of each sample color whose intensity measurement was used to set the numerical range defining each color designation category.

Samples 710-II/A-T plus 720-II/A-K were examples of original sample images named to the red/purple color designation category by sa killed human technician. Samples 710-II/A-T plus 720-II/A-K depict the pseudo-image outputs of the red/purple samples.

Samples 720-II/N-T were examples of original sample images named to the light green color designation category by a skilled human technician. Samples 720-II/N-T depict the pseudo-image outputs of the light green samples.

Samples 730-II/A-T plus 740-II/A-C were examples of original sample images named to the green color designation category by a skilled human technician. Samples 730-II/A-T plus 740-II/A-C depict the pseudo-image outputs of the green samples.

Samples 740-II/K-T were examples of original sample images named to the dark green color designation category by a skilled human technician. Samples 740-II/K-T depict the pseudo-image outputs of the dark green samples.

Samples 750-II/A-L were examples of original sample images named to the yellow/chlorotic color designation category by a skilled human technician. Samples 750-I/A-L depict the pseudo-image outputs of the yellow/chlorotic samples.

FIG. 8. An example of a color classification profile for a green color designation category, with depiction of the statistical mean for a “green” sample as described in Experiment 2. The color classification profile for “green” provides information pertaining to the levels of each of the five different color designation categories of green, dark green, light green, red/purple, and yellow/chlorotic, measured by fraction of sample area represented by pixels in each color designation category.

FIG. 9. An example of a color classification profile for a dark green color designation category, with depiction of the statistical mean for a “dark green” sample as described in Experiment 2. The color classification profile for “dark green” provides information pertaining to the levels of each of the five different color designation categories of green, dark green, light green, red/purple, and yellow/chlorotic, measured by fraction of sample area represented by pixels in each color designation category.

FIG. 10. An example of a color classification profile for a light green color designation category, with depiction of the statistical mean for a “light green” sample as described in Experiment 2. The color classification profile for “light green” provides information pertaining to the levels of each of the five different color designation categories of green, dark green, light green, red/purple, and yellow/chlorotic, measured by fraction of sample area represented by pixels in each color designation category.

FIG. 11. An example of a color classification profile for a red/purple color designation category, with depiction of the statistical mean for a “red/purple” sample as described in Experiment 2. The color classification profile for “red/purple” provides information pertaining to the levels of each of the five different color designation categories of green, dark green, light green, red/purple, and yellow/chlorotic, measured by fraction of sample area represented by pixels in each color designation category.

FIG. 12. An example of a color classification profile for a yellow/chlorotic color designation category, with depiction of the statistical mean for a “yellow/chlorotic” sample as described in Experiment 2. The color classification profile for “yellow/chlorotic” provides information pertaining to the levels of each of the five different color designation categories of green, dark green, light green, red/purple, and yellow/chlorotic, measured by fraction of sample area represented by pixels in each color designation category.

FIG. 13. Images of Arabidopsis thaliana plants grown in low nitrogen growth media. A screen shot output of the present invention, with area numbers and pseudo-color images supplied, and with the original image of the samples provided for comparison to the pseudo-image.

FIGS. 14-A and 14-B. Images of Arabidopsis thaliana plants subjected to cold shock. Images of samples as originally obtained (FIG. 14-A) were compared to a pseudo-image (FIG. 14-B) which was created after normalization and color designation of the pixels. The images were obtained in a 24-bit color system, on a red-green-blue color scale, with intensity for each color measured on a scale of 0-255. Normalization of the image involved removal of background characteristics, including removal of blue pixels, removal of a “corona” shadow effect around plants, and removal of gray (dead) leaves. To improve the results obtained from the methods and systems of the current invention, the background of each image was inverted from its original white color (FIG. 14-A) to black (FIG. 14-B) for better contrast with the foreground pixels.

FIGS. 15-A and 15-B. Images of Arabidopsis thaliana plants subjected to cold shock. A close-up view of a portion of FIG. 14 illustrates how the methods and systems of the current invention depict sample color features such as color variegation (FIGS. 15-A and 15-B). FIG. 15-A depicts the original image and FIG. 15-B depicts the pseudo-image of the same samples.

FIG. 16. Images of Arabidopsis thaliana plants subjected to cold shock. A screen shot as output of the present invention, with area numbers and pseudo-color images supplied.

### DETAILED DESCRIPTION OF THE INVENTION

The present inventors discovered a way to assign and quantify color in biological samples in an automated environment. The present invention allows for the processing and analysis of a large number of biological samples while providing objective rules for color assignment and quantification within each sample. The methods and systems of the current invention allow direct comparison of color from sample to sample, and enable statistical manipulation of larger data sets obtained by the methods and systems of the invention. The invention is highly useful in establishing the health status of the organism from which a sample is obtained.

The three “attributes of color” are hue, saturation, and brightness. Hue refers to the name associated with a color, saturation refers to how much of a color appears to be present, and brightness (or intensity) refers to the perceived amount of light coming from a source. Attributes of color, also referred to as color attributes, are measured by the methods and systems of the invention, and provide numerical values that represent “raw color data,” which is a versatile data type useful in numerous data analysis methods. “Hue” is a term used to denote the psychological attribute most clearly corresponding to wavelength of light and is often referred to as “color.” “Hue” and “color” are used interchangeably herein. “Saturation” is generally considered to be the psychological attribute of a hue associated with how much of the hue is present. “Brightness” is generally thought of as the psychological perception of light intensity.

“Pixels” are known to those of skill in the art of computer imaging, and a single pixel can be described as the smallest discretely addressable part, or the smallest discrete element, of a digital image in a frame buffer. Another way to describe a pixel is to refer to it as the basic unit of the composition of an image on a television screen, computer monitor, or similar display.

A “color space” is a formal method of representing the visual sensations of color, for example by graphical or pictorial means. Once a color space is defined, particular colors can be precisely specified by words and/or numbers. A “color space component” as defined herein is a characteristic used in defining a color space. In one example, the color space components in a red-green-blue (RGB) color space are red, green, and blue. When a particular color attribute is measured, such as intensity, numerical values for the color attribute are measured for each of the color space components of red, green, and blue within a single pixel. Thus, in a RGB color space, a measure of intensity would result in the acquisition of three numerical values. In another example, the color space components in a cyan-magenta-yellow (CMY) color space are cyan, magenta, and yellow. When a particular color attribute is measured, such as intensity, numerical values for the color attribute are measured for each of the color space components of cyan, magenta, and yellow within a single pixel. Thus, in a CMY color space, a measure of intensity would result in the acquisition of three numerical values. Other color spaces are commonly used and are known to those of skill in the art, and can be used in the methods and systems of the present invention.

“Color designation” occurs when color attribute measurement values are obtained for a pixel and a set of rules or parameters pertaining to the color attribute measurement values is followed for assigning the pixel to a particular color designation category. Pixels grouped into a single color designation category are considered to be within a range of similar colors, with the range defined by the parameters used for the color designation. In one example, the numerical range of color attribute measurement values in a single color designation category is broad and the hues of the individual pixels in the category may be quite different. In a color designation system with a broad range of color attribute measurement values in a single color designation category, fine distinctions in color may not be detected. In another example, the range of color attribute measurement values in a single color designation category is narrow and the hues of the individual pixels in the category are quite similar, enabling fine distinctions in color.

The use of color designation categories is superior to other methods of assigning color to samples because the categories are described in a numerical fashion and thus are not only objective, but avoid the pitfalls of overlap and gaps in color designations. When skilled human technicians view samples and assign colors so as to teach a computer application hot to define a particular color, overlap will occur (the same color will be assigned to two different categories) and gaps will be left (if a human technician views and assigns a reasonable number of samples, not every color will be represented and thus there will be no appropriate assignment for some samples encountered after human color designation is completed). Using the methods and systems of the current invention, all designations of color are represented in the color categories with no overlap and no gaps.

Color designation methods and systems provide a way of distilling complex information into a simple, more comprehensible format for further examination and analyses. A color designation can be a component of a “color classification profile” (discussed herein below), but a color classification profile can be represented using raw color data that have not been assigned to color designation categories. Assignment to a color designation category is not a necessity for representation and examination of raw color data collected by the methods and systems of the present invention, but is useful in some embodiments.

Color designation is a category assignment for a pixel, and the parameters or rules defining a particular color designation are determined as needed per experimental application, and may differ significantly from one application to another. A color designation category assignment may be determined, for example, by setting a high or low threshold value for one or more of the color space component attribute values, and/or the color designation may be assigned based on a proportional relationship between two or three color space component attribute measurements. In one example, the color attribute measurement is a measure of intensity, and a higher value for green than for red results in designation of the pixel to the “green” color designation category. In another example, the color attribute measurement is a measure of intensity, a higher value for green than for red confirms that the pixel belongs in one of the “green” color designation categories, and the precise value of the intensity measurement for green determines final assignation of the pixel to either the “light green,” “medium green,” or “dark green” color designation category. In another example, the color attribute measurement is a measure of intensity, and a lower value for green than for red results in designation of the pixel to the “yellow” color designation category. In another example, “foreground pixels” are pixels which are considered to represent at least some part of a sample and which contribute to measurements taken from the sample while “background pixels” are pixels which are considered to represent something other than a sample and which are removed from consideration in taking measurements from the sample. In another example, the color attribute measurement is a measure of intensity, and any pixel containing a green color attribute value below a threshold of 125 on a 0-255 scale is designated as a background pixel and is not analyzed further. In another example, the color attribute measurement is a measure of intensity, the RGB values are approximately equivalent to each other, and the pixel is assigned to the “gray” color designation category, signifying that the pixel is a background pixel and not a foreground pixel.

As noted above, the parameters or rules defining a particular color designation are determined as needed per experimental application, and may differ significantly from one application to another. There is no limit to the number of color designation categories that can be defined for a particular experimental application, other than the mathematical limit existing due to the number of possible measurements. In a 24-bit color system, approximately 16.7 million colors can be defined, so that any number of color designation categories between one and approximately 16.7 million are possible. Since one reason for using color designation categories is to provide a way of distilling complex information into a simpler, more comprehensible format for further examination and analyses, it is likely that the number of color designation categories used in a particular experimental application employing a 24-bit color system will be smaller than 16.7 million. Possible numbers of color designation categories used in a particular experimental application include, for example, 2, 3, 4, 5, 6, 7, 8, 9, 10, 15, 20, 25, 30, 40, 50, or any other integer known to be useful to researchers in the field of the experimental application. Preferred numbers of color designation categories include 2, 3, 4, 5, 6, 7, 8, 9, 10, 11, 12, 13, 14, and 15.

As used herein, the term “color classification profile” refers to a numerical and/or graphical representation of color present in a biological sample, and contains information representative of each foreground pixel found in a region of interest in the sample image. A color classification profile is a highly useful data representation, as it enables depiction of raw color data or any selected subsets thereof, including depiction of data reduced by the use of color designation categories. In one example, the color classification profile is representative of measurements of a single color attribute. In another example, the color classification profile is representative of measurements of two color attributes. In a further example, the color classification is representative of measurements of three color attributes.

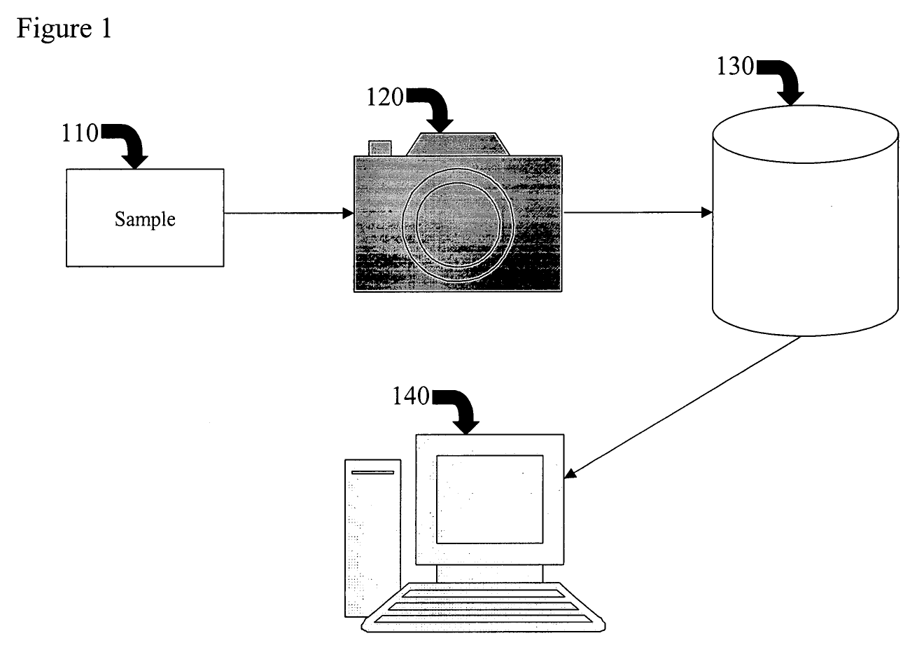

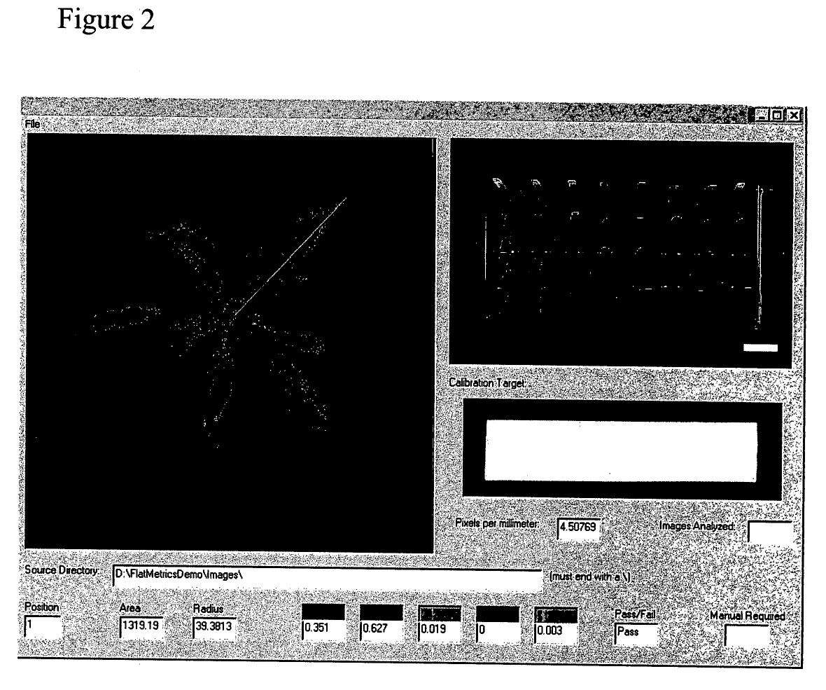

FIG. 1 is a depiction of a system useful in implementing the current invention. In one example, a biological sample is obtained, an image is captured of the sample, the image is stored in a file system, a database or server directory as data, and the methods and systems of the invention are applied to the data for analysis of the sample. In another example, a biological sample is obtained, the sample is placed under a microscope, an image of the sample is captured through the microscope, the image is stored in a database or server directory as data, and the methods and systems of the invention are applied to the data for analysis of the sample. In still another example, the sample is imaged in the field and the methods and systems of the invention are applied to the data as a diagnostic tool for identification of markers for stress or disease.

To support the computer-implemented methods and systems of the current invention, proper technical infrastructure must be available. Appropriate image acquisition devices include a Nikon D70, D1, D1H, D2H or D1X camera fitted with a 60 mm f/2.8 lens (Nikon USA, Melville, N.Y.), but those of skill in the art are familiar with a plurality of other image acquisition devices, and additionally, with numerous other fittings and accessories that may be used in conjunction with the Nikon D70, D1, D1H, D2H or D1X camera bodies to acquire the type of image desired. Appropriate image capture software includes Nikon Capture software (Nikon USA, Melville, N.Y.), but many image capture software applications exist and would be appropriate, including those run on a personal computer and those existing on an image acquisition device. Appropriate computer hardware is supplied, for example, by the Sun Microsystems' E420 workgroup server (Sun Microsystems, Inc., Santa Clara, Calif.). Appropriate operating systems include, but are not limited to, Solaris (Sun Microsystems, Inc., Santa Clara, Calif.), Windows (Microsoft Corp., Redmond, Wash.), or Linux (Red Hat, Inc., Raleigh, N.C.). Appropriate image and data storage solutions include, but are not limited to, relational databases such as Oracle 9.0.1 (9i) (Oracle Corp., Redwood Shores, Calif.), DB2 Universal Database V8.1 (IBM Corp., Armonk, N.Y.), or SQL Server 2000 (Microsoft Corp., Redmond, Wash.). Additionally, a directory of files may be created on a server, wherein the image files are stored in a format such as JPEG (or JPG), TIFF, GIF, BMP, RAW, PNG, or any other format known in the art. In one embodiment of the current invention, the image acquisition device is a Nikon D1X camera fitted with a 60 mm f/2.8 lens (Nikon USA, Melville, N.Y.), the image is captured using Nikon Capture software (Nikon USA, Melville, N.Y.), image files are stored as JPEG files in a directory on the E420 workgroup server (Sun Microsystems, Inc., Santa Clara, Calif.), and the operating system is Windows (Microsoft Corp., Redmond, Wash.). The field of digital image acquisition is rapidly expanding, and further methods of image acquisition are under development. Therefore, it is noted that the methods and systems of the present invention are not limited to any particular image acquisition methods.

The invention described herein is useful in detecting differences between a normal or control group of biological organisms and experimentally manipulated or modified counterpart organisms, also called an experimental group. One example of the usefulness of such detection of differences is comparison of a control group to a genetically modified experimental group, wherein genetic modification may result in an organism that is either more or less robust than normal, or may result in an organism that has a specific strength or weakness in relation to a particular environmental factor, pathogen, or toxin. Other experimental manipulations may include exposure of an organism to a pathogen or toxin, or to anything that may elicit a change in the organism. In a more complex experiment, organisms may be genetically modified and the genetically modified organisms may be exposed to environmental changes, pathogens, and/or toxins. Many other experimental manipulations are familiar to those of skill in the art and are included in the scope of the current invention.

The present invention is useful in many applications, including examination of biological organisms that have experienced a change or alteration in environment. Such environmental changes or alterations may include fluctuations in temperature, moisture, light, and/or nutrient content of food source, or changes induced by introduction of a chemical entity or a pathogen into the environment of an organism. Any of the aforementioned environmental changes may trigger a stress response in an organism, and it is desirable to detect stress responses as early as possible, both in the laboratory for experimental purposes and in the context of daily life so that a countermeasure can be undertaken. In one example, the current invention is used in a laboratory setting, with a stationary computer system and with samples of laboratory origin. In another example, the current invention is used in a laboratory setting, with a stationary computer system and with “real world” samples, or samples which originated outside of a laboratory setting. In another example, the current invention is used in “the real world,” (that is, outside the laboratory), by utilizing portable technology such as a laptop computer. The laptop computer is taken to the location of the samples of interest, including environments such as an agricultural field, an aquatic environment such as a river or ocean, an agronomic environment such as a farm for beef cattle or dairy cattle, a zoo, or an environment containing a population of people of interest, such as a school, a nursing home, or a hospital. Providing portable technology for employing the methods and systems of the present invention removes the need to find a way to transport samples unharmed and thus adds improved efficiency to the image screening process. The invention herein described is particularly useful in detecting visual changes in biological samples, wherein such changes are indicative of a stress response, and is especially useful in enabling detection of stress responses at time points earlier than those detectable when using other techniques for examination of the samples, such as examination by a skilled human technician.

In plants, stress responses are often displayed as morphological characteristics, including leaf curling or wilt, stunted growth, leaf burn (leaf browning as a result of cell death), yellow or chlorotic leaves (indicative of inhibition of chlorophyll production), purple or red leaves (indicative of the formation/accumulation of a reddish-purple anthocyanin pigment that occurs in the form of a water-soluble cyanidin glucoside), or unusually dark green leaves. Other morphological changes observed to correlate with plant stress include root length, root mass, shoot length, and weight of the fresh plant. Easily visualized morphological changes make plant stress assays prime candidates for a high-throughput (HT) image analysis system such as the invention described herein. Animals, including humans, also display physiological changes in response to stress. Many of these changes, including those types of changes that can be analyzed using histology and/or pathology methods, lend themselves to examination in a HT image analysis system.

While plant stress assays are prime candidates for HT image analysis due to existence of easily visualized morphological changes and due to a need for fast and efficient analysis of a large number of samples, it has been difficult to implement such systems due to variability inherent in biological samples and a lack of flexibility for accomodating variability in automated computer-driven systems. The instant invention overcomes these obstacles primarily by enabling improved sample segregation and by altering color classification from a subjective process performed by a skilled technician to an objective process performed completely by a computer-implemented method. The color classification of the current invention is of such robust quality that results are more reproducible than when produced by skilled human technicians, and the color classification enables such fine distinction of color that stress responses can be detected earlier by the methods and systems of the present invention than that detected by the human eye. Efficiency is therefore greatly increased by the current invention, since more plants are analyzed per time unit, results are more reliable and more accurate than that produced by a skilled technician, and the time required for completing a full assay is reduced, as samples can be examined by the methods and systems of the instant invention after a shorter experimental time period than when examination is conducted by a human technician.

The methods and systems of the instant invention require that an image be obtained. Once a suitable image is acquired, it can be adjusted to reduce background or artifacts, or adjusted so that all of the images within a system are normalized and are thus directly comparable to each other. Furthermore, many image manipulations are commonly applied and are known to those of skill in the art. For example, in one instance a normalization process is applied to correct for minor exposure and white balance variations from one sample image to another sample image, and/or to correct for minor exposure and white balance variations from one camera to another camera. In another example, various methods of filtering are applied to an image, to separate foreground pixels from background pixels. It should be noted that some images leave no background pixels, and thus no filtering of background pixels is needed. An example of an image containing no background pixels is an image of a section of an animal tissue, such as a liver, in which the image consists of only a portion of the whole section on a microscope slide. Such images are common in the fields of histology and pathology, or any field in which microscopes are used.

Color assignment performed by a skilled human technician is a subjective process. Typically, the technician will examine a plurality of samples grouped together in a batch. The technician will assign to each sample a color, chosen from, for example, a manageable number of colors, such as five or six predetermined color choices. Such a system gives color “calls,” or assignments, that are not very discriminating, since color is a continuum of millions of values and a technician must practically reduce the millions of colors to a few. Attempts to reproduce color assignment results generated by skilled human technicians are not very successful, as there are inconsistencies with the same technician on different days, and additionally, there are inconsistencies from one technician to another. An improved way of objectively measuring and numerically representing the continuum of colors present in a biological sample was sought by the current inventors and implemented in the methods and systems of the instant invention.

Color assignment performed by the current invention differs from that typically performed in that each individual pixel in an image is examined for the presence of at least one color component contained in the chosen color space. For instance, if the chosen color space is a red-green-blue (RGB) color space, each pixel can be examined for the presence of each of red, and/or green, and/or blue. Any color space can be used in the methods and systems of the invention, including, but not limited to, red green blue (RGB); cyan-magenta-yellow (CMY); hue-saturation-value (HSV); hue-lightness-saturation (HLS); or any of the color spaces defined by the International Commission on Illumination (CIE), such as CIELAB, in which L*a*b* are plotted at right angles to one another and equal distances in the space represent approximately equal color differences, and wherein L* represents the lightness scale, and a*b* represent correlates of hue and chroma; CIELUV, in which L*u*v* are plotted at right angles to one another and equal distances in the space represent approximately equal color differences, and wherein L* represents the lightness scale, and u*v* represent correlates of hue and chroma. Richard Jackson et al. Computer Generated Color: A Practical Guide to Presentation and Display pp. 60-67 (1994).

Additionally, any color attribute can be measured by the methods and systems of the current invention. The three attributes of color are hue, saturation, and brightness. Hue refers to the name associated with a color, saturation refers to how much of a color appears to be present, and brightness (or intensity) refers to the perceived amount of light coming from a source.

For a typical “8-bit” gray scale image in a computer generated color system there are 256 possible stored values, ranging from 0 (black) to 255 (white). The values 0-255 may be, for example, measures of a color attribute such as intensity. For a typical color image in a computer generated color system there are three separate scales of 256 values, one for each color space component, such as the red, green and blue color components in a RGB color scale. An 8-bit system for each color space component in a three-component color scale is a “24-bit” system. The multiplicative effect of three color component values (each with 256 possible numerical assignments) gives a total of approximately 16.7 million color possibilities in a 24-bit color system. The need to objectively distinguish and assign nearly 17 million color possibilities in a 24-bit system necessitated the development of an automated color classification system.

Using the methods and systems of the current invention, color attribute measurements are obtained for individual pixels comprising an image of a biological sample. Once the raw color data numerical values are obtained from the color attribute measurements, a plurality of color designation category parameters or rules can be applied to the raw color data, or the raw color data can be analyzed directly. In one embodiment, color designation category rules are based on historical knowledge of the system under examination. In another embodiment, color designation category rules are created by analyzing color classification profiles comprised of raw color data and creating color designation categories based on groupings of samples with similar raw color data numerical values. In another embodiment, color attribute measurements are used directly in a color classification and are not subjected to color designation rules.

The only limit to the number of color designation categories possible is the number of numerical values present in the color system (for example, approximately 16.7 million values in a 24-bit system), thus ensuring that the data collected by the methods and systems of the current system are meaningful across a wide variety of analyses. An important feature of the instant invention is that application of a first set of color designation category parameters to the raw color data does not preclude application of a second set or further sets of color designation category parameters to the same raw color data.

In one embodiment, the present invention provides computer-implemented methods and systems for classifying color in an image of a biological sample comprising: obtaining an image of a biological sample, the image comprising a plurality of pixels, with each pixel comprising a plurality of color space components; measuring a color attribute for at least one color space component within each pixel in the image; assigning a numerical value representative of the color attribute to each color space component measured within each pixel; and determining a color classification profile for the sample based on the numerical value assigned to each color space component measured.

In another embodiment, the present invention provides computer-implemented methods and systems for classifying color in an image of a biological sample comprising: obtaining an image of a biological sample, the image comprising a plurality of pixels, with each pixel comprising a plurality of color space components; measuring a color attribute for at least one color space component within each pixel in the image; assigning a numerical value, representative of the color attribute, to each color space component measured; defining at least one color designation category by a numerical range; assigning each pixel to a color designation category based on the numerical value assigned to each color space component measured, with the individual numerical values or the proportionalities of the individual numerical values within a pixel contributing to the color designation category assignment; and determining a color classification profile for the sample based on the color designation category assignment for each pixel.

One major advantage of employing automated HT screening techniques is that a large number of samples can be processed quickly. Proper handling of large numbers of samples requires precise placement of samples in a known format, such as rows, columns, or grids, to enable computer detection of individual samples. The presence of grid lines in an image enables computer recognition of individual samples by separating sample positions, thus defining an image area in which no more than one sample will be found. Common sample layouts or configurations include 1×10, 8×4, 8×8, 8×12, and 32×48, but sample placement format can be adjusted in any way that best suits a process, as long as the format, layout, or configuration is recognized by the computer applications used to implement the HT screening. Sample placement formats that are commonly known in the art include, but are not limited to, 96-well microtiter plates, 384-well microtiter plates, 1536-well microtiter plates, 8 samples in a row across a petri plate, samples in a row across a petri plate, an 8×8 sample format in a petri plate, and 32 plant pots in an 8×4 array in a flat, but other formats for sample containment and/or support are known in the art such as, but not limited to, microscope slides, synthetic membranes, multiwell plates, petri plates, test tubes, microfuge tubes, and plant pots. FIG. 2 depicts an output screen of the present invention in which plant pots in an 8×4 array in a flat were used.

Placement of biological samples in a particular format is not a process that can always be precisely controlled. Biological samples of the same type are never identical, resulting in immediate and omnipresent variability, and change subsequent to sample placement, such as growth or death, often results in further irregular sample patterns or sample placement, even when rigorous measures have been implemented to ensure that the samples conform to a chosen format on the plate. The difficulty of ensuring that biological samples adhere to a particular format is one characteristic that makes automation of biological screening processes especially difficult. The present invention provides methods and systems for automatically adjusting grid lines in an image of a sample, thus permitting movement of grid lines to accommodate deviation in sample placement within a chosen sample placement format. Adjustment of grid lines ensures that samples are properly accounted for by the computer system, even when there is sample placement irregularity that causes deviation from the strictly prescribed layout format.

The current invention provides methods and systems for adjusting image grid lines to accommodate samples in a specified format, with the objective of implementing the grid lines to separate sample positions and enable computer recognition of individual samples. A “grid line,” as described herein, consists of demarcation of a single line of pixels and, optimally, is placed in the image in such a way that no foreground pixels are included in the pixels making up the grid line. In one embodiment, the samples are on a media plate in a single row of 8. In another embodiment, the samples are on a media plate in an 8×8 format. In another example, the samples are in a 96-well or 384-well plate. In another example, the samples are in an array of 8×4 pots.

Proper placement of grid lines on an image requires knowledge of the edges or boundaries of the image under consideration. The edges are designated prior to placement of grid lines. Designation of edges occurs in a way best suited to a particular experimental application. In one embodiment, edges are determined to correspond to the edges of a sample containment system, such as edges of a 96-well plate, edges of a plant flat, or edges of a petri dish. In another embodiment, edges are determined manually. In still another embodiment, edges are adjusted in the same way that grid lines are adjusted, permitting movement of edge lines to accommodate deviation in sample placement within a chosen sample placement format. Once edges have been placed, they serve as an axis of origin and an axis of completion for placement of grid lines on the image.

In one embodiment of the methods and systems of the present invention, a human technician inputs a number of grid lines required based on a number of samples, since some samples are not detectable but must be accounted for when adjusting grid lines to accomodate a particular sample format. In one example, a plant sample is not detectable due to death of the sample. In another example, a plant sample is not detectable due to sowing of a seed that is not viable. In another example, a plant sample is not detectable due to accidental omittance of the sample during sample placement. In a further example, a plant sample is not detected because its placement and/or growth pattern has placed it, or some part of it, in the space formatted for a neighboring sample. Examples of required number of grid lines include, but are not limited to, the following. In one example, a sample format of a single row of 8 requires 7 grid lines. In another example, a sample format of a single row of 10 requires 9 grid lines. In another example, a sample format of 8×8 requires 7 horizontal grid lines and 7 vertical grid lines. In another example, a sample format of 8×12 requires 7 horizontal grid lines and 11 vertical grid lines. In another example, a sample format of 12×8 requires 11 horizontal grid lines and 7 vertical grid lines. In another example, a sample format of 32×48 requires 31 horizontal grid lines and 47 vertical grid lines. In another example, a sample format of 48×32 requires 47 horizontal grid lines and 31 vertical grid lines. In another example, a sample format of 8×4 requires 7 horizontal grid lines and 3 vertical grid lines. In another example, a sample format of 4×8 requires 3 horizontal grid lines and 7 vertical grid lines.

To accomplish the objective of implementing grid lines in an image to separate sample positions and enable recognition of individual samples, a search is implemented for a grid line position that excludes at least one type of pixel from its path along a single straight line (for example, a row, a diagonal row, or a column) of pixels. In one embodiment, a type of pixel to be excluded from a grid line is a foreground pixel. The search for foreground pixels begins at a first designated point and proceeds in a pixel-by-pixel stepwise, or incremental, fashion along a first single line of pixels. If a foreground pixel is encountered as the grid line placement application proceeds pixel-by-pixel in a straight path along the first single line of pixels, the stepwise progress along the first single line of pixels ceases. The grid line placement application returns to a pixel position on the axis neighboring the first designated pixel and begins a new stepwise search for foreground pixels along a single line parallel to the first single line.

Rules for excluding at least one type of pixel from a grid line will vary from one application to the next, as different image acquisition processes require different manipulations. Some image acquisition processes provide images on which there are artifacts which make background pixels appear to be foreground pixels. The presence of such artifacts increases the difficulty of finding a foreground pixel-free path on which to place a grid line. In processes where the images tend to contain such artifacts, a threshold approach can be applied to the the rule of exclusion of at least one type of pixel from a grid line. Such thresholding could include rules such as the allowance of up to six consecutive foreground pixels before a potential grid line position is abandoned. Another example of thresholding is identification of a minimum pixel number for any features of interest in the image, and allowance of any group of consecutive foreground pixels smaller than the minimum pixel number for features of interest in a grid line. For example, if a minimum pixel number for a feature of interest is identified as 30 pixels, then any number of consecutive foreground pixels up to and including 29 is allowable in a grid line. If 30 or more consecutive pixels are found to be in a potential grid line path, the path is abandoned. This type of threshold approach allows a human technician to tailor the placement of grid lines to the approach most acceptable in any particular situation.

Different screening processes have different grid line requirements. Some sample formats require grid lines only in a single direction, while other sample formats require grid lines in two directions that are perpendicular to one another (the grid lines in one direction are parallel to each other, but perpendicular to the grid lines in the second direction). Other sample formats require any range of two-dimensional patterns, including radial patterns, concentric circles, and diagonal patterns. Any two-dimensional sample format is aided by the present invention for a sample demarcation method and system that shifts, expands, or contracts grid lines as needed. For the purpose of describing the methods and systems of the present invention, a horizontal grid line is said to lie parallel to the X axis, while a vertical grid line is said to lie parallel to the Y axis, as in a typical Cartesian coordinate system. The X and Y axes form the edges of the sample format and are not adjustable. Positions along the X and Y axes serve as position origins for grid lines. Positions along each axis are described in terms of pixel locations, with each axis considered in single pixel increments and a single integer unit assigned to each pixel. A grid line that lies parallel to the X axis has its point of origin on the Y axis, and a grid line that lies parallel to the Y axis has its point of origin on the X axis. Each grid line is assigned a starting position on an image, described by pixel location. In one embodiment, the methods and systems of the current invention provide for incremental movement, pixel by pixel, across the plate perpendicular to the path of its axis of origin, continuing as long as each pixel encountered is a background pixel, and until a foreground pixel is encountered. If the grid line encounters a foreground pixel in its path, the foreground pixel-containing path is no longer followed and is abandoned, and the grid line path is shifted over to the next pixel on the axis of origin, thereby again beginning the pixel by pixel movement across the plate, noting whether each pixel encountered is background or foreground, and, if a foreground pixel is encountered, abandoning the path and shifting over to a next pixel on the axis of origin.

The search for proper grid line placement is conducted within specifications detailed by the sample format used. In one example, nine grid lines of X axis origin are specified for a sample format of ten samples in a row across a petri plate. Each grid line begins at a designated position on the X axis and lies perpendicular to the X axis. The locations of the nine grid lines are described as follows: a first grid line is designated “X-axis position 101-105,” a second grid line is designated “X-axis position 201-205,” a third grid line is designated “X-axis position 301-305,” a fourth grid line is designated “X-axis position 401-405,” a fifth grid line is designated “X-axis position 501-505,” a sixth grid line is designated “X-axis position 601-605,” a seventh grid line is designated “X-axis position 701-705,” an eighth grid line is designated “X-axis position 801-805,” and a ninth grid line is designated “X-axis position 901-905.”

In the current example, the search for first grid line “X-axis position 101-105” originates at X-axis position 103. If no foreground pixels are encountered in the path originating at X-axis position 103, a grid line is placed at X-axis position 103 and the search moves to the next grid line position specified, which in the current example is at a position between pixel 201 and pixel 205 inclusive. If a foreground pixel is encountered in the path followed from the origin of X-axis position 103, X-axis position 103 path is abandoned. The next position originates at position 102. If no foreground pixels are encountered in the path originating at X-axis position 102, a grid line is placed at X-axis position 102 and the search moves to the next grid line position specified, which in the current example is at a position between pixel 201 and pixel 205 inclusive. If a foreground pixel is encountered in the path followed from the origin of X-axis position 102, X-axis position 102 path is abandoned. The next position originates at position 104. If no foreground pixels are encountered in the path originating at X-axis position 104, a grid line is placed at X-axis position 104 and the search moves to the next grid line position specified, which in the current example is at a position between pixel 201 and pixel 205 inclusive. If a foreground pixel is encountered in the path followed from the origin of X-axis position 104, X-axis position 104 path is abandoned. The next position originates at position 101. If no foreground pixels are encountered in the path originating at X-axis position 101, a grid line is placed at X-axis position 101 and the search moves to the next grid line position specified, which in the current example is at a position between pixel 201 and pixel 205 inclusive. If a foreground pixel is encountered in the path followed from the origin of X-axis position 101, X-axis position 101 path is abandoned. The next position originates at position 105. If no foreground pixels are encountered in the path originating at X-axis position 105, a grid line is placed at X-axis position 105 and the search moves to the next grid line position specified, which in the current example is at a position between pixel 201 and pixel 205 inclusive. If a foreground pixel is encountered in the path followed from the origin of X-axis position 105, X-axis position 105 path is abandoned. As soon as any path originating from positions 101-105 is found to contain no foreground pixels from the pixel of origin to a designated pixel of completion, a grid line is placed along that path in the image and the search ends for grid line “X-axis position 101-105.” If none of X-axis positions 101-105 provide a straight line of pixels containing no foreground pixels, one of several things may happen. In one example, a grid line is created for grid line “X-axis position 101-105” at the first grid line location considered, which was X-axis position 103. A message or signal may accompany the grid line to alert a human technician that foreground pixels are included in the line of pixels demarcating the grid line. In another example, no grid line is placed and a warning message is displayed. In a third example, a human technician may manually place a grid line at a position that seems most appropriate. Completion of these tasks completes the automated placement of grid line “X-axis position 101-105,” and automated placement of a second grid line “X-axis position 201-205” begins. In the present example, the process continues as described above until grid line placement has been examined for each of the nine grid line positions. Note that in a real image, pixel positions would number in the thousands, but the numbers used in the above example were chosen to simplify the explanation and enhance understanding of the process.

### EXAMPLE 1

### Color Classification

The present invention is useful in many applications, including, but not limited to, the examination of biological organisms that have been subjected to an altered environment or a change in environment. Such alterations or changes may include fluctuations in temperature, moisture, light, and/or nutrient content of food source, or alterations or changes induced by introduction of a chemical entity into the environment of the organism. The invention is highly useful in establishing the health status of the organism from which a sample is obtained.

In one example, hereinafter referred to as Experiment 1, an automated system for identifying stressed versus non-stressed plants was desired. An automated system for distinguishing different levels of stress from one plant to another was also desired. Prior methods commonly used to determine plant stress include 1) observing the color of plant leaves, 2) collecting leaf reflectance data, and 3) measuring total nitrogen, carbon, and/or potassium concentration in a leaf (Fridgen and Varco (2004) Agronomy Journal, 96:63-69; Gilbert et al., (1998) Journal of Experimental Botany, 49:107-114). Method 1 above may provide observation of areas of different color within a sample, but the output is subjective. Methods 2 and 3 above provide an average value for an entire sample, where a sample is, for example, a partial or whole leaf or a number of leaves or plant parts. The present invention provides objective information for the entire area of the sample, resulting in a plurality of measurements that are used to indicate areas of different color within a sample and also, in some embodiments, are used to provide a value that can be applied to the sample as a whole. In other words, a variegated or mottled sample, or a sample with one or more areas different from the rest of the sample, can be identified by the present invention, but such comprehensive sample information is either not conveyed at all (e.g., Methods 2 and 3 above) or is not conveyed in an objective manner (e.g., Method 1 above) by methods known to those of skill in the art.

The effects of various environmental stresses on plant nitrogen levels, chlorophyll levels, and anthocyanin levels have been measured in various ways in an effort to identify the effects of stress on plants. (Fridgen and Varco, supra; Gilbert et al., supra; Chalker-Scott (2004) Photochemistry and Photobiology 70:1-9). Prior to the current invention, methods were known for determining plant stress, as discussed in the previous paragraph, but the prior methods are not automated and do not provide for storage of data in such a way that a variety of analysis methods can be applied. A further disadvantage of known methods for determining plant stress is that the prior methods are destructive to the sample, while the methods and systems of the current invention preserve the sample in its original state. Sample preservation enables tracking of a single sample throughout an experimental time course, which is useful in some embodiments.

One method used to determine plant stress, referred to as Method 2 above, is to measure, with a spectrophotometer, the wavelength of light reflected from a plant leaf. However, Method 2 does not capture an image that can be re-analyzed or reviewed later, does not provide a means for identification of characteristics such as yellow spots or a mottled leaf appearance, and only provides an average wavelength value for the sample.

A second method previously used, referred to as Method 3 above, is to extract the total nitrogen or anthocyanin from the plant and measure the amount present as a percentage of total leaf extract, as exemplified in Gilbert et al. or in Fridgen and Varco. However, Method 3 is time-, space-, and labor-intensive (to grow and harvest enough plant material for obtainment of total leaf extract to determine total nitrogen and/or anthocyanin levels), is destructive to the sample, and provides an average value for the entire sample and does not provide a way in which characteristics such as yellow spots or a mottled leaf appearance can be captured.

In Experiment 1, as noted above, an automated system for identifying stressed versus non-stressed plants was desired. An automated system for distinguishing different levels of stress from one plant to another was also desired. Images of Arabidopsis thaliana plants, which were subjected to media containing varying concentrations of nitrogen, were obtained in a 24-bit color system, on an RGB color scale, with intensity measured for each color on a scale of 0-255. Levels of nitrogen provided to the plants for which total nitrogen extract was measured included 0.2 mM, 0.4 mM, 0.8 mM, 2.0 mM, and 4.0 mM. Levels of nitrogen provided to the plants for which total anthocyanin extract was measured included 0.4 mM, 0.8 mM, 10.0 mM, 20.0 mM and 30.0 mM. Levels of total nitrogen extract and total anthocyanin extract were measured to confirm correlation between prior methods used to examine plant stress and the methods and systems of the present invention. Nitrogen content (measured from extract) corresponded to green/red ratio values of approximately 65-85 in the methods and systems of the present invention. Anthocyanin content (measured from extract) corresponded to green/red ratio values of approximately 100-135 in the methods and systems of the present invention.

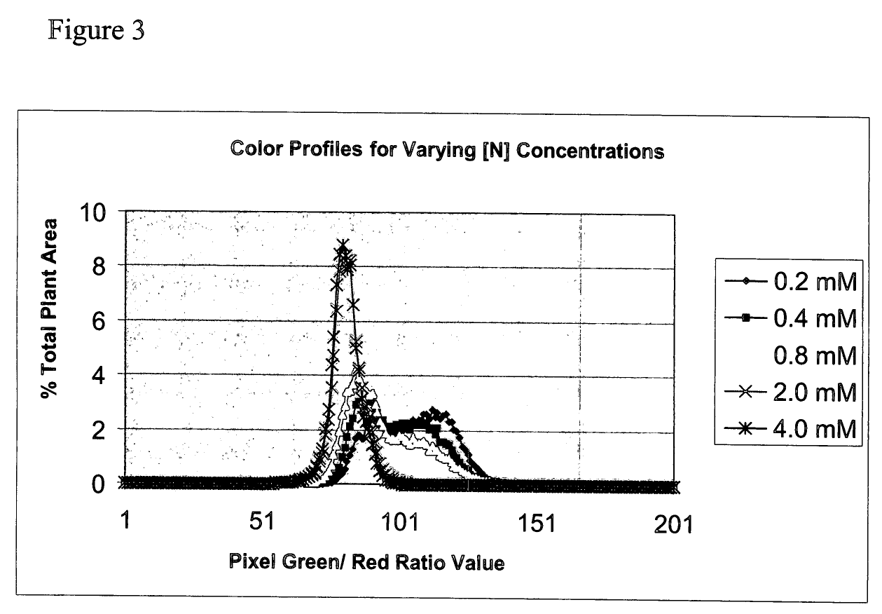

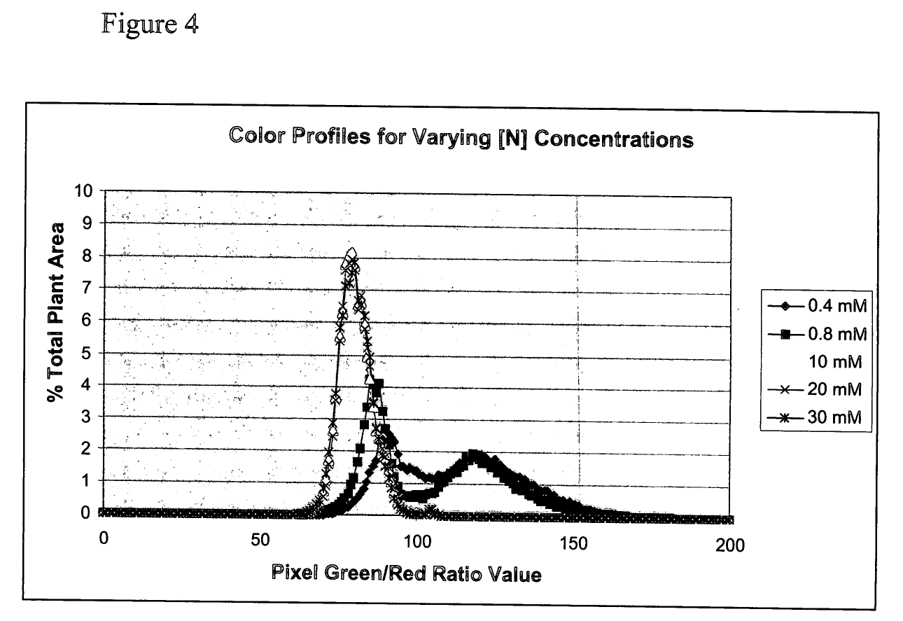

After the raw color intensity values were acquired for each pixel, a green/red ratio was determined. These values were plotted in a histogram fashion (FIGS. 3 and 4). These data are highly valuable in enabling the distinction of stressed versus non-stressed plants, or in resolving stress differentials between plants. Healthy, non-stressed plants produced a single peak on the “green” side of the plot, at green/red ratio values of approximately 65-85 (FIG. 3, samples 2.0 mM and 4.0 mM; and FIG. 4, samples 10 mM, 20 mM, and 30 mM). Stressed plants produced two peaks on the histogram, one on the green side of the plot at green/red ratio values of approximately 65-85, and a second one towards the red side of the plot, at green/red ratio values of approximately 100-135 (FIG. 3, samples 0.2 mM, 0.4 mM and 0.8 mM; and FIG. 4, samples 0.4 mM and 0.8 mM). Both the size of the peaks and the location of the peaks on the horizontal axis of the graph provide an indication of plant stress level, allowing further distinction within the stressed plant group. This example illustrates the utility of obtaining a color classification profile directly from raw color data, without the need for further dividing data into color designation categories.

### EXAMPLE 2

### Color Classification Using Five Color Designation Categories

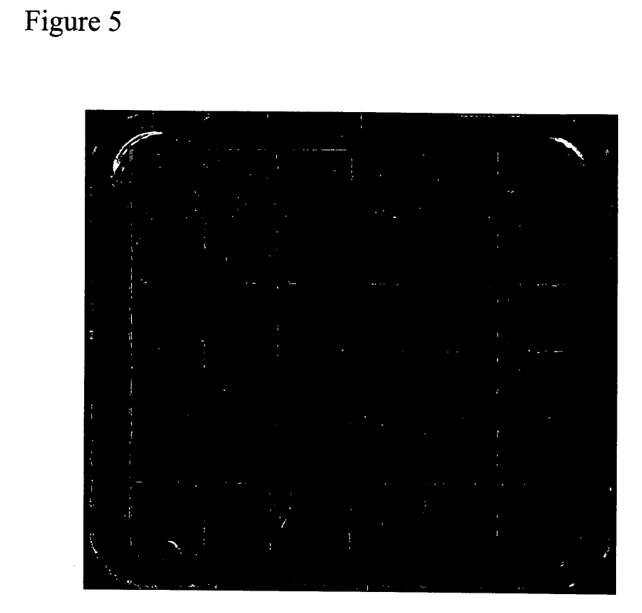

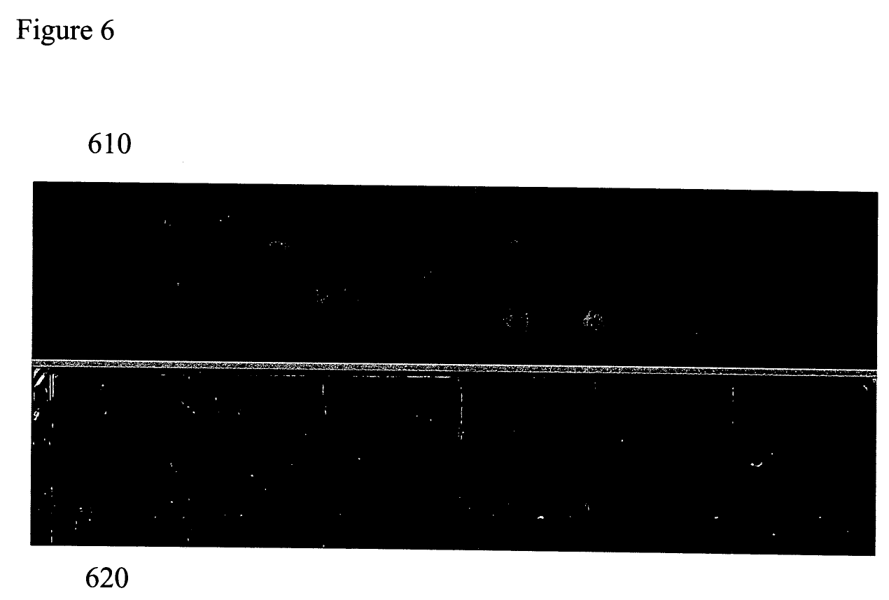

In another example, hereinafter referred to as Experiment 2, color assignments were made to Arabidopsis thaliana plants subjected to low nitrogen levels in growth media. Images of the plants, which were grown in rows of 8 on media in plastic plates, were obtained (FIG. 5). The images were obtained in a 24-bit color system, on an RGB color scale, with intensity for each color measured on a scale of 0-255. Normalization of the images involved removal of background characteristics, including identification and removal of characteristics such as plant roots, plate ribs, bubbles in media, reflections from plastic plates, and gray (dead) plant leaves. FIG. 6 depicts the samples in the original image (620, lower row) compared to the pseudo-image (610, upper row) created after normalization and after “contrast stretching.” Contrast stretching was employed to enhance color differences in the pseudo-image of the plants, and was implemented by proportionally extending the intensity values to more fully utilize the entire 0-255 scale for each color.

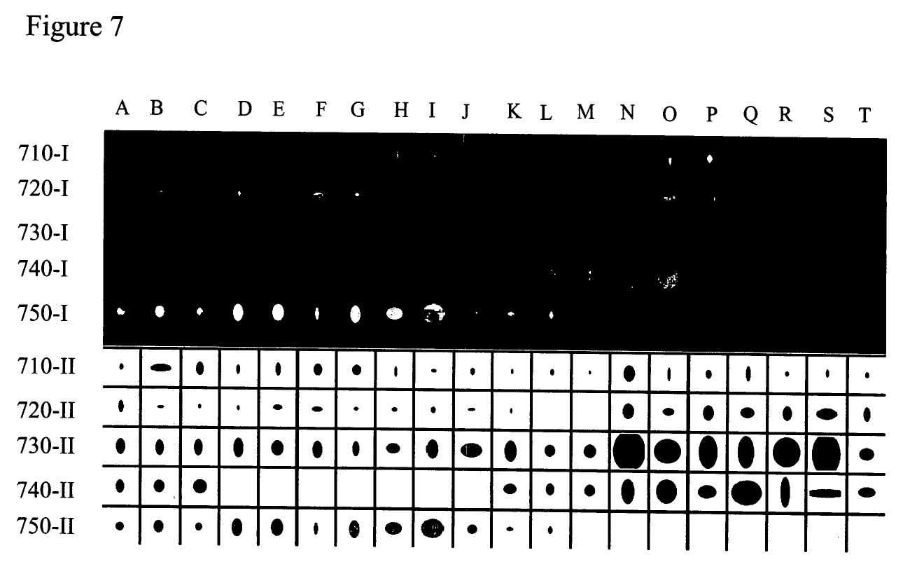

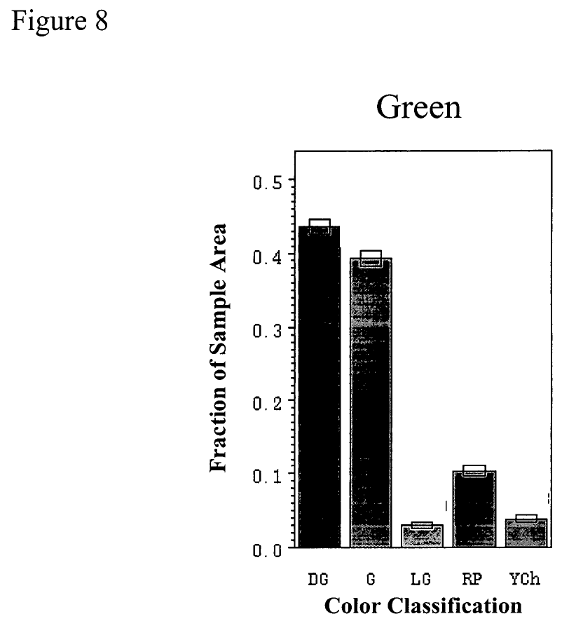

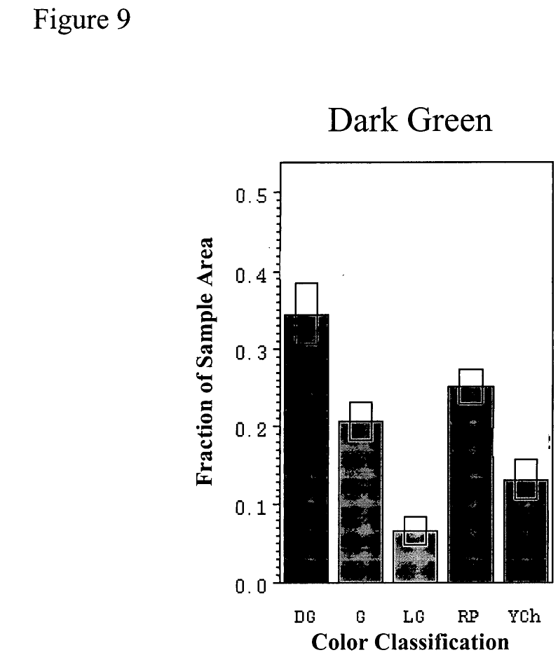

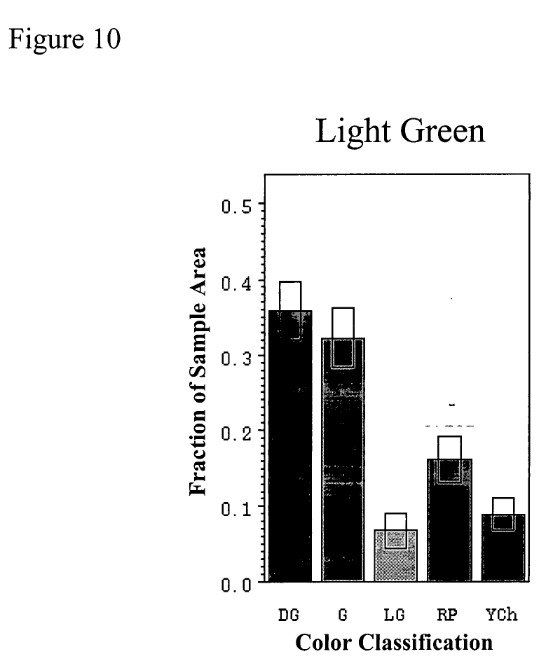

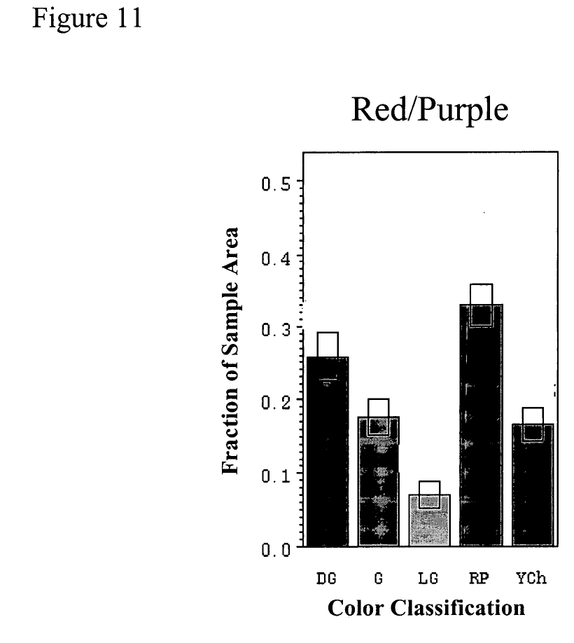

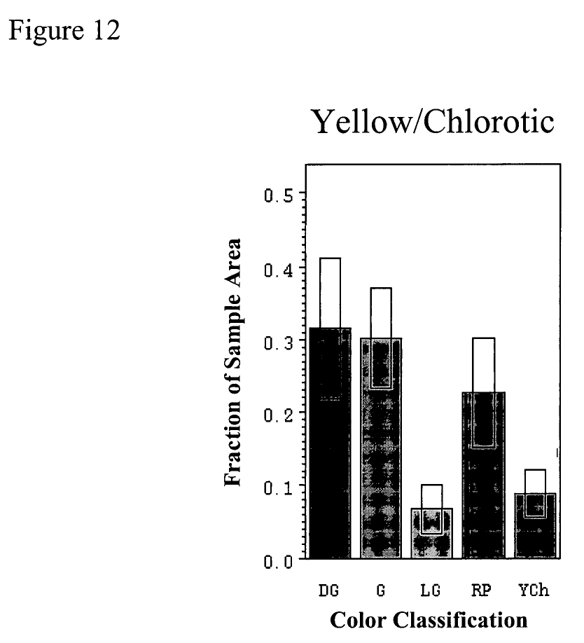

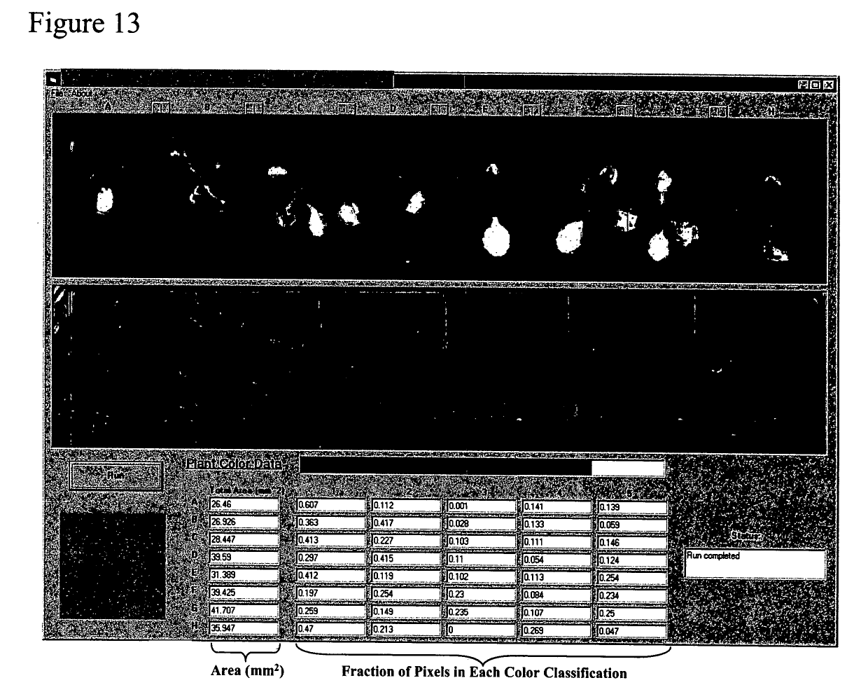

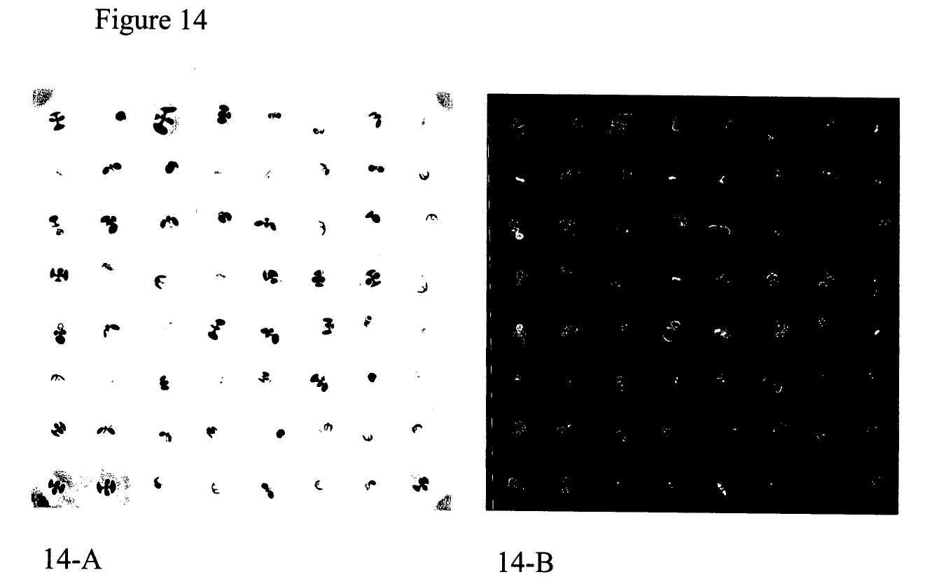

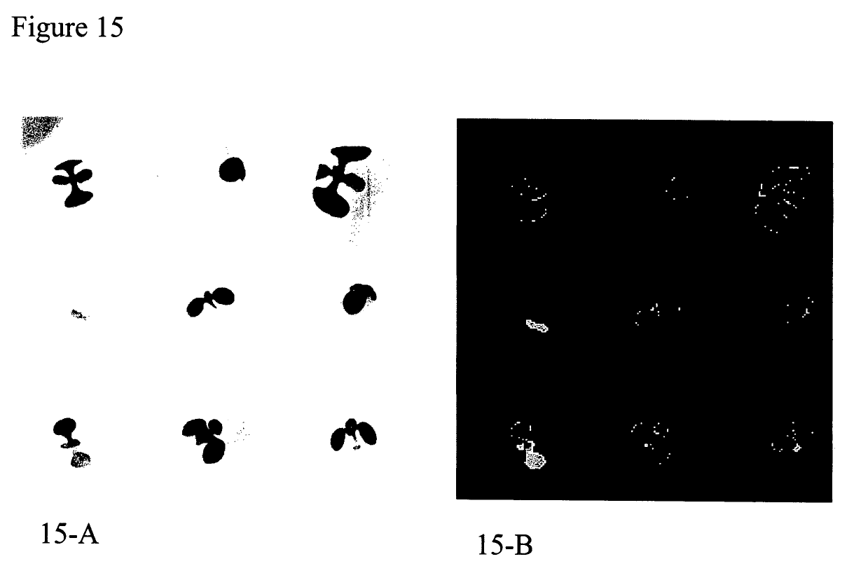

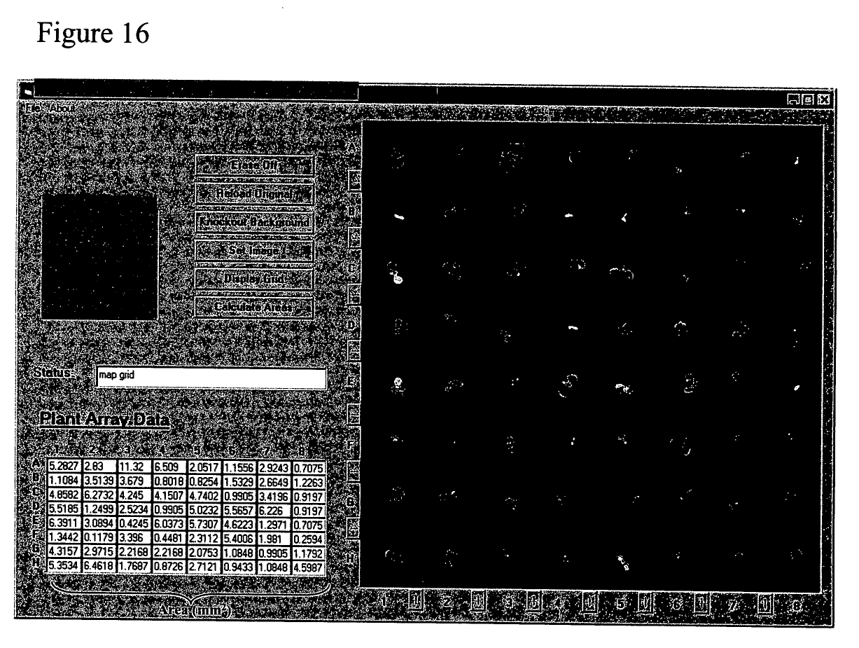

Next, five color designation categories known to be useful in the examination of plants subjected to low nitrogen levels were identified and examples of plants of each color designation category were provided by human technicians. The color designation categories were referred to as “green,” “dark green,” “light green,” “red/purple,” and “yellow/chlorotic.” The methods and systems of the present invention were tuned in an iterative process, aided by the use of composite images, until the pseudo-image output results provided by the invention were matched to color assignments made by a skilled human technician (FIG. 7). The compiled results represented in FIG. 7 provide numerous examples of each sample color wherein an intensity measurement was used to set the numerical range defining each color designation category. Final validation for Experiment 2 as conducted using the methods and systems of the current invention provided results for 114 images containing 8 plant samples per image, with superior results provided by the present invention due to the increased information and consistency provided, as discussed below.

One advantage conveyed by the instant invention is the fine level of distinction possible between samples. Data provided by a human technician consists simply of assigning each sample to a single color designation category. Color assignment provided by the invention includes information about the amount of each color designation category present in each sample. Thus, the data obtained from use of the current invention provide a color classification profile for each sample. In the case of Experiment 2, the color classification profile was comprised of five color designation categories for each sample, rather than the one color designation category obtained when color assignment was performed by a human technician. FIGS. 8-12 depict color classification profiles, with each Figure depicting the statistical mean of one of the five color designation categories used in Experiment 2. Each color classification profile (FIGS. 8-12) provides information pertaining to the levels of each of the five different color designation categories of green, dark green, light green, red/purple, and yellow/chlorotic, measured by fraction of pixel area represented in each color designation category. Data procurement methods and systems of the present invention provide substantially more information (five times more in the case of Experiment 2) than that which can be provided by a skilled human technician, and the data are stored in a numerical format that can be analyzed in a variety of ways. Raw color data values obtained and stored in the image analysis of the present invention can be viewed without assignment to color designation categories (as illustrated in FIGS. 3 and 4 above) or can be viewed within the parameters of a plurality of color designation category groupings.

In Experiment 2, an area measurement was calculated for each sample. The area measurement required knowledge of the particular camera with which the image was obtained, the pixel per millimeter ratio of the camera, and the inclusion of all foreground pixels recognized for each image. A pseudo-color image was supplied, allowing researchers to visualize the results of the image analysis. A pseudo-color image is a representation of the color designations assigned by the methods and systems of the invention and provides a visual indication of the color assignments made to the samples. Area numbers and pseudo-color images were supplied as outputs of the invention, with the original image of the samples provided for comparison to the pseudo-image (see FIG. 13).

FIG. 13 also depicts the adjustment of grid lines (red vertical lines in pseudo-image) so that the individual samples can be distinguished from one another more easily, thus guiding proper separation of individual samples for a more accurate measure of area. As can be seen in FIG. 13, the small lines in gray squares at the top of the page, between the sample identifiers A-H, mark a designated first grid line position. However, if foreground pixels, which were to be excluded from the grid lines, were encountered at the first grid line positions, alternate positions were examined as described herein above. The utility of adjustable grid lines is well illustrated here, as the grid lines between samples A-B, C-D, E-F, and G-H were all adjusted to avoid inclusion of foreground pixels. Thus, in the current example, four of seven grid lines required adjustment. Additionally, the grid line between F-G could not be placed in a position that would exclude all foreground pixels (due to overlapping plant leaves), and was therefore placed at a position chosen by a human researcher examining the data.

Overall, Experiment 2 showed that while single plant color designations as called by human technicians corresponded to dramatic changes in the color designation categories as analyzed by the methods and systems of the invention, the methods and systems of the invention were better able to distinguish between greens and red/purples that were less dramatic in difference, thus providing more consistent and reliable results than those provided by human technicians.

An important benefit provided by the present invention is that the methods and systems described herein can be utilized in the form of a primary assay. In the past, color-based screening was not efficient, objective and/or reliable enough to use as a primary screen and was instead used as a secondary screen to validate a result determined by a different assay. When using the efficient and objective methods of the instant invention, statistical methods can be employed to determine which samples are of interest in an experiment such as Experiment 2. Thus, in one embodiment, the methods and systems of the instant invention comprise an effective primary assay.

### EXAMPLE 3

### Color Classification Using Six Color Designation Categories

In another example, hereinafter referred to as Experiment 3, color assignments were made to Arabidopsis thaliana plants subjected to cold shock, which is a common environmental stress factor for plants. Images of the plants, which were grown in an 8×8 format on media in plastic plates, were obtained at a specified time point (FIG. 14). Images were obtained in a 24-bit color system, on an RGB color scale, with intensity of each color measured on a scale of 0-255. Normalization of the images involved removal of background characteristics, including removal of blue pixels, removal of a “corona” shadow effect around plants, and removal of gray (dead) leaves. To improve the results obtained from the methods and systems of the current invention, the background of each image was inverted from its original white color (FIG. 14-A) to black (FIG. 14-B) for better contrast with the foreground pixels. FIG. 14 depicts samples in an image as originally obtained (FIG. 14-A) compared to a pseudo-image (FIG. 14-B) created after normalization and color designation of the pixels. A close-up view of a portion of FIG. 14 illustrates how the methods and systems of the current invention depict sample color features such as color variegation (FIGS. 15-A and 15-B).

Next, six color designation categories known to be useful in the examination of plants subjected to cold shock treatment were identified and examples of plants of each color designation category were provided by human technicians. The color designation categories were referred to as “green,” “dark green,” “very dark green,” “light green,” “red/purple,” and “yellow/chlorotic.” The methods and systems of the present invention were tuned in an iterative process, aided by the use of composite images, until the pseudo-image output results provided by the invention were matched to color assignments made by skilled human technicians, as discussed above in Example 2.

Again, an advantage provided by the instant invention is the fine level of distinction possible between samples. Data provided by human technicians consisted simply of assigning each sample to a single color designation category. Color assignment provided by the invention included information about the amount of each color designation category present in each sample. Thus, the data obtained from use of the current invention provided a color classification profile for each sample. In the case of Experiment 3, the color classification profile was comprised of six color designation categories for each sample, rather than one color designation category as was obtained when color assignment was performed by a human technician. Each color classification profile obtained in Example 3 provided information pertaining to the levels of each of the six different color designation categories of green, dark green, very dark green, light green, red/purple, and yellow/chlorotic, measured by fraction of pixel area represented in each color designation category. Data procurement methods and systems of the present invention provide substantially more information (six times more in the case of Experiment 3) than that which can be provided by a skilled human technician, and the data are stored in a numerical format that can be analyzed in a variety of ways. The raw color data values obtained and stored in the image analysis of the present invention can be viewed without assignment to color designation categories (as illustrated in FIGS. 3 and 4 above) or can be viewed within the parameters of a plurality of color designation category groupings as defined by a human technician.

In Experiment 3, an area measurement was calculated for each sample. Area measurement required knowledge of the particular camera with which the image was obtained, the pixel per millimeter ratio of the camera, and the inclusion of all foreground pixels recognized for each pixel. A pseudo-color image was supplied, allowing researchers to visualize the results of the image analysis. A pseudo-color image is a representation of the color designations assigned by the methods and systems of the invention and provides a visual indication of the color assignments made to the samples. Area numbers and pseudo-color images were supplied as outputs of the invention (FIG. 16). Total area values are also available in a spreadsheet format, along with the fraction of area contributed by each color designation category. Fraction of area values can be used to graphically represent a color classification profile, such as the ones depicted in FIGS. 8-12.

FIG. 16 depicts grid lines (red vertical and horizontal lines) that are adjustable so that individual samples can be distinguished from one another more easily, thus guiding proper separation of individual samples for a more accurate measure of area. As can be seen in FIG. 16, the small lines in raised gray boxes below and to the left of the plant images mark a designated first grid line position. However, if foreground pixels, which were to be excluded from the grid lines, were encountered at the first grid line positions, alternate positions were examined as described herein above. The utility of adjustable grid lines is illustrated in Experiment 3, for example, as the grid line between numbers 6-7 was adjusted to avoid inclusion of foreground pixels.

Overall, Experiment 3 proved that while single plant color designations as called by the human technicians corresponded to dramatic changes in the color designation categories as analyzed by the methods and systems of the invention, the methods and systems of the invention were better able to distinguish between greens and red/purples that were less dramatic in difference, thus providing more consistent and reliable results than those provided by humans.

Published references and patent publications cited herein are incorporated by reference as if terms incorporating the same were provided upon each occurrence of the individual reference or patent document. While the foregoing describes certain embodiments of the invention, it will be understood by those skilled in the art that variations and modifications may be made that will fall within the scope of the invention. The foregoing examples are intended to exemplify various specific embodiments of the invention and do not limit its scope in any manner.

What is claimed is:

1. A computer-implemented method for classifying color in an image of a biological sample, comprising:
a) obtaining an image of a biological sample, the image comprising a plurality of pixels, with each pixel comprising a plurality of color space components;
b) measuring a color attribute for at least one color space component within each pixel in the image;
c) assigning a numerical value representative of the color attribute to each color space component measured within each pixel; and
d) determining a color classification profile for the sample based on the numerical value assigned to each color space component measured.

2. The method according to claim 1, wherein the color space is selected from the group consisting of a red-green-blue color space, a cyan-magenta-yellow color space, a CIELAB color space, and a CIELUV color space.

3. The method according to claim 1, wherein the color space is a red-green-blue color space.

4. The method according to claim 1, wherein the color attribute is intensity.

5. The method according to claim 1, wherein the color space is a red-green-blue color space, the color attribute is intensity, and the color space components measured are red and green.

6. The method according to claim 1, wherein a 24-bit color system is employed, the color space is a red-green-blue color space, the color attribute is intensity, and the numerical value representative of the color attribute is measured on a scale of 0-255.

7. A computer-implemented method for classifying color in an image of a biological sample, comprising:
a) obtaining an image of a biological sample, the image comprising a plurality of pixels, with each pixel comprising a plurality of color space components;
b) measuring a color attribute for at least one color space component within each pixel in the image;
c) assigning a numerical value representative of the color attribute to each color space component measured;
d) defining at least one color designation category by a numerical range;
e) assigning each pixel to a color designation category based on the numerical value assigned to each color space component measured, wherein the individual color attribute numerical values or the proportionalities of the individual color attribute numerical values within a pixel contribute to the color designation category numerical range; and
f) determining a color classification for the sample based on the color designation category assignment for each pixel.

8. The method according to claim 7, wherein the color space is selected from the group consisting of a red-green-blue color space, a cyan-magenta-yellow color space, a CIELAB color space, and a CIELUV color space.

9. The method according to claim 7, wherein the color space is a red-green-blue color space.

10. The method according to claim 7, wherein the color attribute is intensity.

11. The method according to claim 7, wherein the number of color designation categories is selected from the group consisting of two, five and six.

12. The method according to claim 7, wherein the color space is a red-green-blue color space, the color attribute is intensity, and the color components measured are red and green.

13. The method according to claim 7, wherein the color space is a red-green-blue color space, the color attribute is intensity, the color components measured are red and green, and the color designation category is defined by proportionality between the red and green color components.

14. The method according to claim 7, wherein a 24-bit color system is employed, the color space is a red-green-blue color space, the color attribute is intensity, the color components measured are red and green, and the numerical value representative of the color attribute is measured on a scale of 0-255.

15. A computer-implemented method for placement of a grid line on an image depicting at least one biological sample, comprising:
a) establishing an axis of origin and an axis of completion for a grid line to be placed on an image;
b) identifying a group of pixel positions on the axis of origin at which the grid line could originate;
c) determining at least one type of pixel to be excluded from the grid line;
d) selecting a first pixel position from the group of pixel positions on the axis of origin and proceeding toward the axis of completion pixel by pixel until either the axis of completion is reached and a grid line is placed or a pixel to be excluded is encountered;
e) selecting a next pixel position from the group of pixel positions on the axis of origin if a pixel to be excluded is encountered and proceeding toward the axis of completion pixel by pixel until either the axis of completion is reached and a grid line is placed or a pixel to be excluded is encountered; and
f) repeating step (e) until a grid line position with no pixels to be excluded is found among the group of pixel positions or until every position in the group of pixel positions has been examined.

16. The method according to claim 15, wherein if every position in the group of pixel positions has been examined in step (f) and no position lacking pixels to be excluded is found, one of the following actions is selected:
a) a grid line is placed at the first pixel position on the axis of origin;
b) no grid line is placed and a message is displayed; or
c) a grid line is placed by a human technician.

17. The method according to claim 15, wherein the type of pixel to be excluded from the grid line is a foreground pixel.

18. A computer-implemented system for classifying color in an image of a biological sample, comprising:
a) means for obtaining an image of a biological sample, the image comprising a plurality of pixels, with each pixel comprising a plurality of color space components;
b) means for measuring a color attribute for at least one color space component within each pixel in the image;
c) means for assigning a numerical value representative of the color attribute to each color space component measured within each pixel; and
d) means for determining a color classification profile for the sample based on the numerical value assigned to each color space component measured.

19. The system according to claim 18, wherein the color space is selected from the group consisting of a red-green-blue color space, a cyan-magenta-yellow color space, a CIELAB color space, and a CIELUV color space.

20. The system according to claim 18, wherein the color space is a red-green-blue color space.

21. The system according to claim 18, wherein the color attribute is intensity.

22. The system according to claim 18, wherein the color space is a red-green-blue color space, the color attribute is intensity, and the color space components measured are red and green.

23. The system according to claim 18, wherein a 24-bit color system is employed, the color space is a red-green-blue color space, the color attribute is intensity, and the numerical value representative of the color attribute is measured on a scale of 0-255.

24. A computer-implemented system for classifying color in an image of a biological sample, comprising:
a) means for obtaining an image of a biological sample, the image comprising a plurality of pixels, with each pixel comprising a plurality of color space components;
b) means for measuring a color attribute for at least one color space component within each pixel in the image;
c) means for assigning a numerical value representative of the color attribute to each color space component measured;
d) means for defining at least one color designation category by a numerical range;
e) means for assigning each pixel to a color designation category based on the numerical value assigned to each color space component measured, wherein the individual color attribute numerical values or the proportionalities of the individual color attribute numerical values within a pixel contribute to the color designation category numerical range; and
f) means for determining a color classification for the sample based on the color designation category assignment for each pixel.

25. The system according to claim 24, wherein the color space is selected from the group consisting of a red-green-blue color space, a cyan-magenta-yellow color space, a CIELAB color space, and a CIELUV color space.

26. The system according to claim 24, wherein the color space is a red-green-blue color space.

27. The system according to claim 24, wherein the color attribute is intensity.

28. The system according to claim 24, wherein the number of color designation categories is selected from the group consisting of two, five and six.

29. The system according to claim 24, wherein the color space is a red-green-blue color space, the color attribute is intensity, and the color components measured are red and green.

30. The system according to claim 24, wherein the color space is a red-green-blue color space, the color attribute is intensity, the color components measured are red and green, and the color designation category is defined by proportionality between the red and green color components.

31. The system according to claim 24, wherein a 24-bit color system is employed, the color space is a red-green-blue color space, the color attribute is intensity, the color components measured are red and green, and the numerical value representative of the color attribute is measured on a scale of 0-255.

32. A computer-implemented system for placement of a grid line on an image depicting at least one biological sample, comprising:
a) means for establishing an axis of origin and an axis of completion for a grid line to be placed on an image;
b) means for identifying a group of pixel positions on the axis of origin at which the grid line could originate;
c) means for determining at least one type of pixel to be excluded from the grid line;
d) means for selecting a first pixel position from the group of pixel positions on the axis of origin and proceeding toward the axis of completion pixel by pixel until either the axis of completion is reached and a grid line is placed or a pixel to be excluded is encountered;
e) means for selecting a next pixel position from the group of pixel positions on the axis of origin if a pixel to be excluded is encountered and proceeding toward the axis of completion pixel by pixel until either the axis of completion is reached and a grid line is placed or a pixel to be excluded is encountered; and
f) means for repeating step (e) until a grid line position with no pixels to be excluded is found among the group of pixel positions or until every position in the group of pixel positions has been examined.

33. The system according to claim 32, wherein if every position in the group of pixel positions has been examined in step (f) and no position lacking pixels to be excluded is found, one of the following actions is selected:
a) a grid line is placed at the first pixel position on the axis of origin;
b) no grid line is placed and a message is displayed; or
c) a grid line is placed by a human technician.

34. The system according to claim 32, wherein the type of pixel to be excluded from the grid line is a foreground pixel.
